(19) United States
(12) Patent Application Publication
(10) Pub. No.: US 2012/0173258 A1
(43) Pub. Date: Jul. 5, 2012

(54) METHODS AND APPARATUS FOR QUALITY MANAGEMENT OF HEALTHCARE DATA

(75) Inventors: Matthew Hofmann, Allston, MA (US); Adam Weinstein, Belmont, MA (US); Christopher Barnes, Quincy, MA (US); Kimberly Ryan, North Attleboro, MA (US); Justin Seger, (US); Brady Richards, Allston, MA (US); Joseph Holtschlag, Brighton, MA (US); Jeremy Delinsky, Natick, MA (US)

(73) Assignee: athenahealth, Inc., Watertown, MA (US)

(21) Appl. No.: 12/983,835

(22) Filed: Jan. 3, 2011

(51) Int. Cl. G06Q 50/00

(52) U.S. Cl. 705/2

(57) ABSTRACT

Methods and apparatus for providing clinical decision support to a healthcare provider. Eligibility criteria and quality measure information for a plurality of performance-based programs is stored and shared quality measures across performance-based programs are identified. Provider and patient characteristics are compared to the stored eligibility criteria and quality measure information to determine which quality measures apply to which providers and patients of the providers. A healthcare provider is provided with a notification at the point of care indicating a recommended action that, when performed by the healthcare provider will satisfy a quality measure in compliance with one or more performance-based programs. Customized reports may be generated and transmitted to program sponsors of performance-based programs, based on formatting rules specified by the program sponsors.

### BACKGROUND

A recent focus on reducing healthcare costs while improving the quality of healthcare services has resulted in the creation of hundreds of private and government programs where reimbursement for healthcare services is tied to performance in specific measures. For example, the Center for Medicare and Medicaid Services in the U.S. Department of Health and Human Services created a program in 2006 called the Physician Quality Reporting Initiative (PQRI), which provides incentive payments for eligible physicians who satisfactorily report data on quality measures for qualified professional services furnished to Medicare beneficiaries. Additionally, several healthcare service payers (e.g., health insurance companies) have created programs such as pay-for-performance (P4P) (also known as “value-based purchasing”) programs that reward healthcare providers for meeting certain performance measures for quality and efficiency.

In order to become eligible to participate in such performance-based programs, healthcare providers and/or the patients of healthcare providers are required to satisfy one or more criteria established by the program for eligibility. Staff at the healthcare provider's office may monitor the currently available programs to establish the provider's eligibility and ensure that reporting data is transmitted to particular programs in a manner and format required by the program.

### SUMMARY

Although the creation of P4P and other performance-based healthcare programs provides significant opportunities for healthcare providers to supplement conventional reimbursement for medical services with incentive payments, the requirements and procedures that healthcare providers must follow to qualify for such incentive payments varies between programs. Providers may often be unaware of particular programs for which they may qualify resulting in a loss of potential revenue. Some conventional approaches of identifying appropriate programs for a provider rely on human staff and/or generalized clinical decision support rules that are not specific to a particular program. Such rules may not accurately portray performance against specific program rules and may not identify specific programs based on a history of claims filed by the provider. Some embodiments of the invention are directed to a program identification framework that combines multiple sources of information for a provider to enable the provider to identify and enroll in applicable programs for which the provider qualifies.

Additionally, in some instances quality measures that are used to determine incentive payments are similar across programs, although providers may be unaware of these similarities resulting in an inefficient collection and reporting system. Applicants have recognized and appreciated that the efficiency of collection and reporting for quality measures may be improved by providing clinical decision support at the point of care to alert clinicians when a performance measure applies to the current patient, based, for example, on the patient's demographics, medical history, and insurance. To this end, some embodiments of the invention are directed to identifying shared and unique attributes between quality measures in multiple programs to provide information to physicians during patient visits.

Some embodiments of the present invention are directed to a method of providing clinical decision support to a healthcare provider. The method comprises determining, with at least one processor, whether at least one quality measure applies to a patient, wherein the at least one quality measure is associated with at least one performance-based program; and providing, in response to determining that the at least one quality measure applies to the patient, a notification indicating at least one recommended action that, when performed, satisfies the at least one quality measure in compliance with the at least one performance-based program.

Some embodiments are directed to at least one computer-readable medium encoded with a plurality of instructions that, when executed by a computer, perform a method. The method comprises accessing at least one storage device configured to store eligibility information for a plurality of performance-based programs; determining based, at least in part, on a matching between the eligibility information and at least one characteristic of a healthcare provider, whether the least one healthcare provider qualifies for at least one of the plurality of performance-based programs; and enrolling, when it is determined that the at least one healthcare provider qualifies for the at least one of the plurality of performance-based programs, the at least one healthcare provider in the at least one of the plurality of performance-based programs.

Some embodiments are directed to a computer system comprising at least one storage device configured to store a plurality of computer-readable instructions; and at least one processor programmed to execute the plurality of computer-readable instructions to perform a method. The method comprises determining whether at least one quality measure applies to a patient, wherein the at least one quality measure is associated with at least one performance-based program; and providing, in response to determining that the at least one quality measure applies to the patient, a notification indicating at least one recommended action that, when performed, satisfies the at least one quality measure in compliance with the at least one performance-based program.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram of a practice management system in accordance with some embodiments of the invention;

FIG. 2 is a block diagram illustrating a plurality of information sources accessible by a quality management component of the practice management system shown in FIG. 1;

FIG. 3 is a schematic of a portion of a user interface for entering performance-based program information, in accordance with some embodiments of the invention;

FIGS. 4A and 4B are portions of a user interface for entering quality measure information, in accordance with some embodiments of the invention;

FIG. 5 is a flow chart of a program identification process in accordance with some embodiments of the invention;

FIG. 6 is a flow chart of a quality measure matching process in accordance with some embodiments of the invention;

FIG. 7 is a schematic of a portion of a user interface for displaying a notification to a healthcare provider, in accordance with some embodiments of the invention;

FIG. 8 is a flow chart of a report generating process in accordance with some embodiments of the invention; and

FIG. 9 is a schematic of a network environment in which some embodiments of the invention may be employed.

### DETAILED DESCRIPTION

The present disclosure generally relates to inventive methods and apparatus for evaluating healthcare data to facilitate a healthcare provider's participation in one or more performance-based healthcare programs. As discussed above, hundreds of private and public (e.g., government) performance-based healthcare programs such as pay-for-performance (P4P) programs have been recently established in an effort to reduce healthcare costs and improve the quality of healthcare delivered. However, because of the large number of programs available and the often diverse patient populations of a healthcare provider, it is often difficult for a healthcare provider to identify and participate in as many performance-based programs as possible, resulting in a loss of potential revenue.

Applicants have recognized and appreciated that the process of identifying performance-based programs that a provider is eligible for may be improved by comparing information about the healthcare provider and/or healthcare data for one or more patients of the provider with criteria for one or more performance-based programs stored by a practice management system. In some embodiments, healthcare data may include claims history data indicating medical services a patient has received in the past. When a patient is seen by a healthcare provider, the patient provides the healthcare provider with healthcare data that may be used in connection with embodiments of the invention to facilitate the identification of applicable performance-based programs. For example, healthcare data provided by patients may include, but is not limited to, demographic information (e.g., age, gender), medical history information (e.g., social history, vaccine history, surgery history, allergies), and medical insurance information. Some or all of this healthcare data may be considered alone or in combination with other healthcare data when determining if the particular patient qualifies for inclusion in one or more performance-based programs.

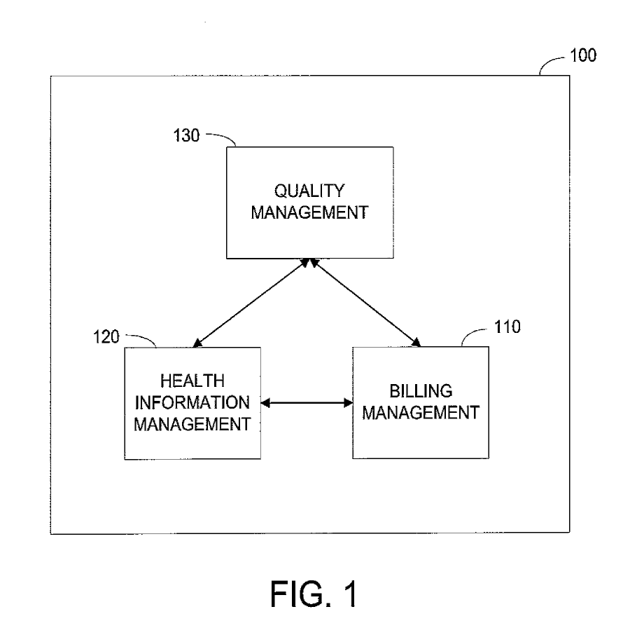

In accordance with some embodiments, a practice management system, which hosts an electronic health records (EHR) system for a healthcare provider may analyze healthcare data to facilitate an identification of performance-based programs as described above. A block diagram of an exemplary practice management system that may be used to implement some embodiments of the invention is shown in FIG. 1. Practice management system 100 may be a networked system that includes a plurality of components configured to perform tasks related to specific functions within the practice management system to facilitate management of information for healthcare providers.

Exemplary practice management system 100 includes billing management component 110, which is configured to facilitate the collection and tracking of claims filed by the healthcare provider to a plurality of payers (including patients) to ensure that the healthcare provider is properly compensated for medical services rendered to patients treated by the healthcare provider. Practice management system 100 also includes health information management component 120, which is configured to store electronic health information such as EHR data for patients of the healthcare provider. Practice management system 100 also includes quality management component 130, which interacts with health information management component 120 and billing management component 110 to facilitate a healthcare provider's participation in one or more performance-based programs.

Although practice management system 100 is only shown as having three components, it should be appreciated that practice management system 100 may include any number of components that interact in any suitable way and embodiments of the invention are not limited in this respect. For example, in some embodiments, practice management system 100 may include a communications component configured to send and/or receive one or more communications with a plurality of patients having medical information stored by health information management component 120. Furthermore, some or all of the components in practice management system 100 may interact by sharing data, triggering actions to be performed by other components, prevent actions from being performed by other components, storing data on behalf of other components, and/or interacting in any other suitable way.

In some embodiments, practice management system 100 includes one or more storage devices configured to store data related to one or more performance-based healthcare programs. The stored data may include, but is not limited to, eligibility criteria for participation in the program, one or more quality measures that participants in the program should provide to receive incentive payments, and formatting information describing a particular format that the program requires for reporting data. The amount and specificity of stored data may vary from program to program and embodiments of the invention are not limited in the amount or degree to which data about particular programs are stored by a practice management system. For example, some programs may be associated with broad quality measures (e.g., vital signs) that include one or more specific quality measures (e.g., blood pressure, heart rate, etc.). In some embodiments, quality management component 130 may compare quality measures across different programs to identify similar quality measures, as described in more detail below.

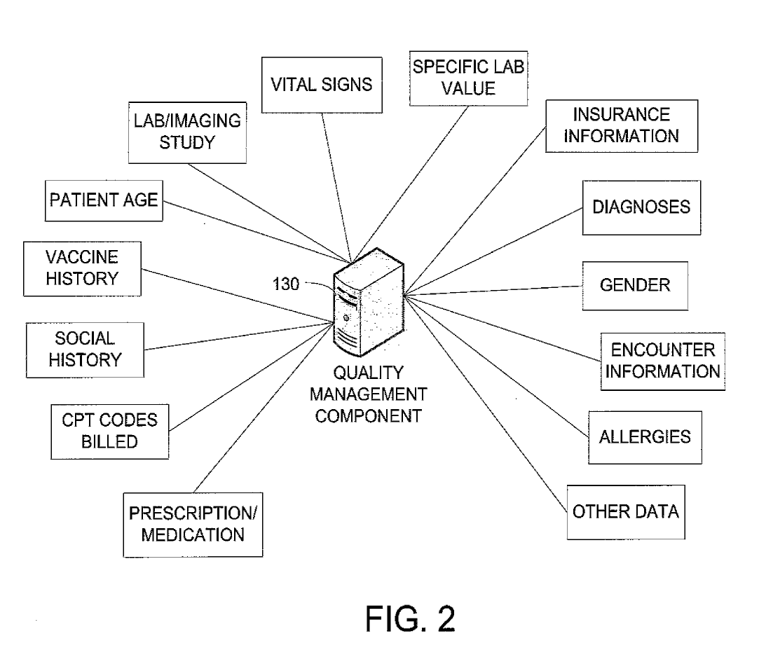

As illustrated in FIG. 2, quality management component 130 may have access to and may interact with a plurality of patient and practice information sources to facilitate a provider's identification of and participation in a plurality of performance-based programs.

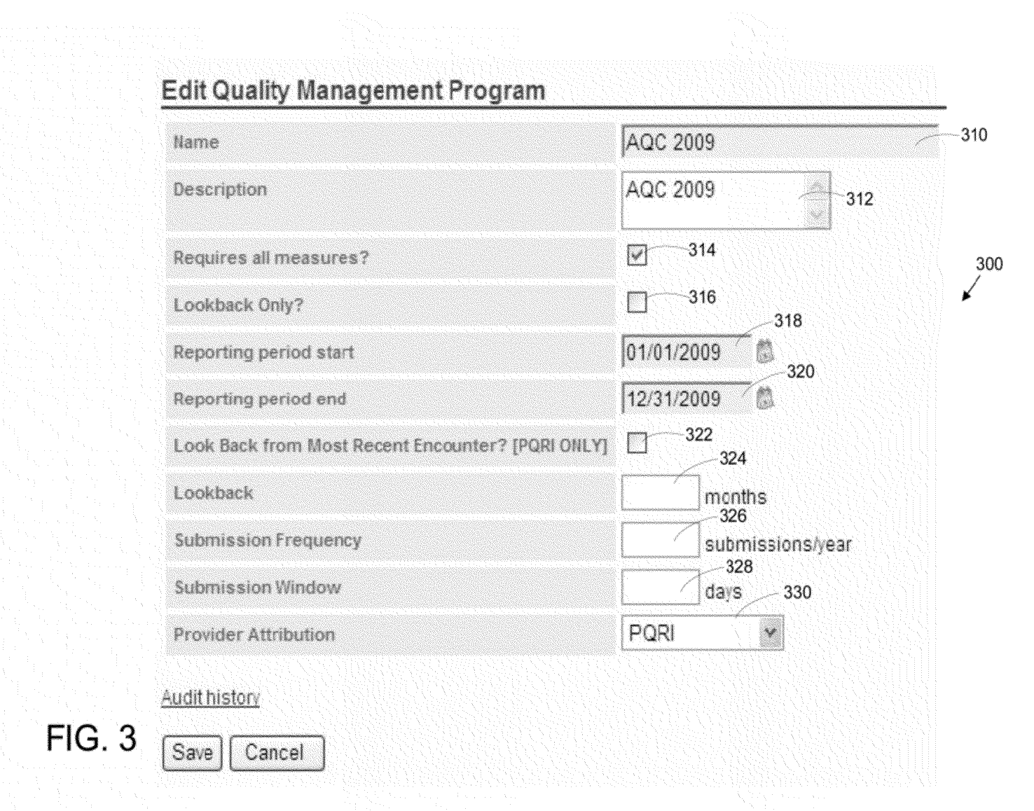

In some embodiments, an administrator of a practice management system (or other authorized individual) may enter or update stored data for a particular performance-based program in a practice management system using program administrator screen 300, as shown in FIG. 3. In some embodiments, program administrator screen 300 may be implemented as a portion of a user interface configured to enable a user to enter program data into the practice management system. In one implementation, program administrator screen 300 may include a plurality of fields that enable a user to define or edit parameters for a performance-based program. For example, program administrator screen 300 may include name field 310 and description field 312 that enable a user to provide general identifying information about the program. Program administrator screen 300 may also include one or more selectors for indicating which conditions apply to the program being created or edited. For example, some programs may require that all quality measures identified for the program be collected and transmitted for the healthcare provider to receive incentive payments, whereas other programs may accept a subset of the identified quality measures. A user may interact with all measures selector 314 to indicate whether the program requires all measures or not. Although shown as a checkbox, selectors displayed on program administrator screen 300 may be any suitable type of selector including, but not limited to a checkbox, a radio button, a drop-down menu, or any other suitable type of selector as embodiments of the invention are not limited in this respect.

Program administrator screen 300 may also include other selectors such as lookback only selector 316 and lookback from recent encounter selector 322. Some performance-based programs may be associated with a pre-defined reporting period (e.g., calendar year 2011), whereas other performance-based programs may include reporting guidelines that look back a specified amount of time from a particular day (e.g., look back one year from the current day when the patient is being seen). If the performance-based program being defined is of the type that does not have a fixed date range for a reporting period, a user may select lookback only selector 316 to indicate that the reporting period for the performance-based program depends on when a quality management assessment by the quality management component of the practice management system occurs (e.g., when a patient is being seen at a medical practice) or some other time, such as the date of the most recent encounter. If the performance-based program reporting guidelines indicate that the reporting period should be a preset amount of time from the most recent encounter, a user may select lookback from recent encounter selector 322 to inform the quality management component of the practice management system that a patient's most recent encounter should be used as the date for looking back in time. If the particular program uses lookback reporting criteria, a user may interact with lookback field 324 to specify the number of months previous to a designated lookback date for which healthcare data should be reported to the program sponsor. Although some fields on program administrator screen 300 display particular time intervals (e.g., days, months, years, etc.), it should be appreciated that any suitable time intervals may alternatively be used and embodiments of the invention are not limited in this respect.

As discussed briefly above, some performance-based programs have fixed reporting periods. In accordance with some embodiments, program administrator screen 300 may additionally include one or more date selectors, such as date selectors 318 and 320, with which a user may interact to specify dates during the fixed reporting range that the particular program requires data to be collected and/or reported to the program sponsor. Submission requirements of the program sponsor may also be indicated using submission frequency field 326 and/or submission window field 328. Some embodiments may include one or more additional reporting information fields (not shown), with which a user may interact to specify specific requirements for reporting for the program including, but not limited to, document type, formatting, and transmission mode. As reporting requirements for different performance-based programs change, the corresponding information associated with the quality management component of the practice management system may be updated to ensure that reports generated for the program comply with the most up-to-date reporting requirements. Program administrator screen 300 may also include provider attribution selector 330, which enables a user to select provider attribution information.

Although exemplary program administrator screen 300 as illustrated in FIG. 3 includes particular fields and selectors that may be used to specify information for a performance-based program, aspects of the invention are not limited to the particular embodiments shown in FIG. 3. For example, some embodiments of the invention may include more that one program administrator screen for specifying program information and/or different types of programs may be associated with different program administrator screens for entering program information.

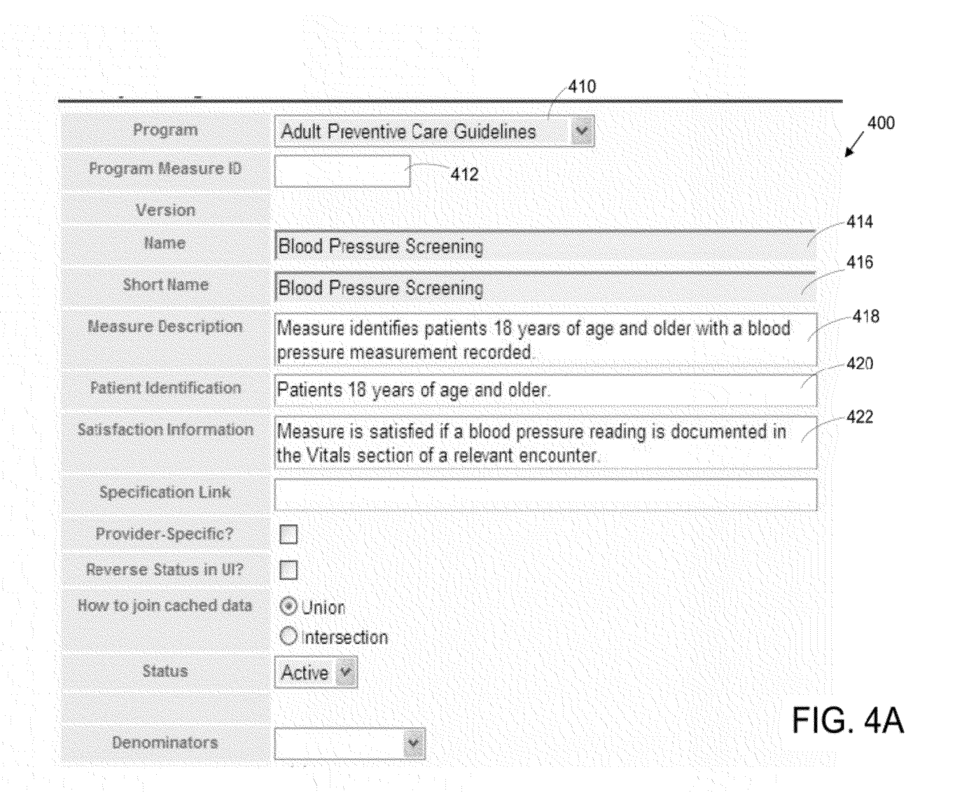

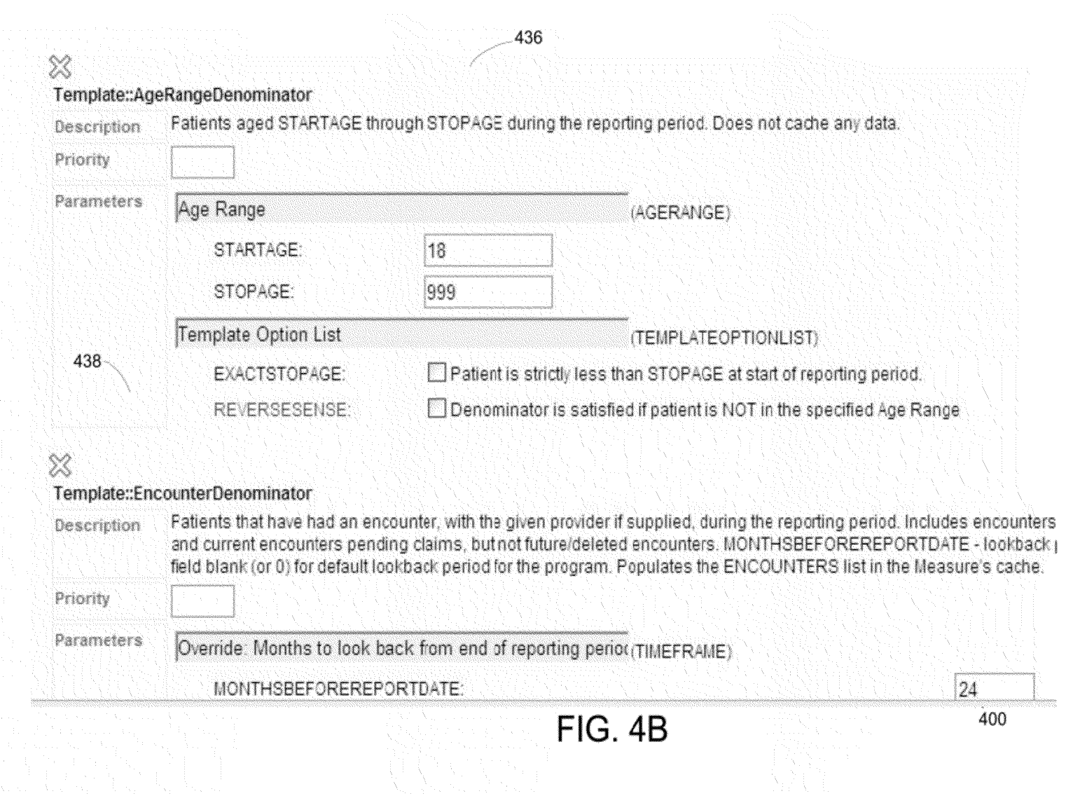

After information regarding a performance-based program has been entered using program administrator screen 300, a user may interact with quality measure screen 400 to enter information related to one or more quality measures for the program. An exemplary quality measure screen 400 is shown in FIGS. 4A and 4B. In some embodiments, quality measure screen 400 may be implemented as a portion of the same user interface as program administrator screen 300, although quality measure screen may alternatively be implemented as a portion of a separate user interface and embodiments of the invention are not limited in this respect.

As shown in FIG. 4A, quality measure screen 400 may include program selector 410 that enables a user to select a program from one or more programs defined using program administrator screen 300. Some quality measures may be associated with identification information. Quality measure screen 400 may include ID field 412, with which a user may interact to associate such identification information with a particular quality measure. In some embodiments, quality measure screen may include one or more other fields for providing descriptive information related to the quality measure being defined or edited. For example, the exemplary quality measure screen 400 illustrated in FIG. 4A includes name field 414, short name field, 416, and description field 418, patient identification field 420, and satisfaction information field 422. Although five descriptive fields are shown for quality measure screen 400, it should be appreciated that any suitable number of descriptive fields may alternatively be used.

Quality measure screen 400 may additionally include one or more other user interface controls to enable a user to specify various attributes of the quality measure including, but not limited to, whether the quality measure is specific to a provider and how to merge cached data for the quality measure.

In some instances, a quality measure may be specified according to numerator and denominator inclusion information and at least one or both of numerator and denominator information may be associated with a quality measure by interaction with at least one portion of patient measure screen 400. Denominator information describes a subset of patients that are to be included in the quality measure. For example, denominator information for a quality measure for depression diagnoses may specify that all insured enrollees age eighteen and over who have been diagnosed with a new episode of major depression should be included in the quality measure. A user may interact with quality measure screen 400 to specify these criteria for denominator information.

In some embodiments, quality measure screen 400 may include or more denominator templates to facilitate the entry of denominator information for a quality measure. FIG. 4B illustrates two examples of denominator templates presented as a portion of quality measure screen 400. Age range template 436 comprises a plurality of predefined fields to enable a user to enter an age range for patients to be included in the quality measure. For example, if the age range for the quality measure is eighteen and older, as described above, a user may interact with age range template to indicate this age range. Similarly, a user may interact with other denominator templates, such as encounter template 438 to specify other criteria that describe patients that are to be included in the quality measure. Any suitable number of denominator templates may be included as part of quality measure screen 400 as aspects of the invention are not limited in this regard.

Some quality measures may also include numerator information that specifies information pertaining to a subset of patients that fit the denominator inclusion criteria. Continuing with the depression example above, numerator information may specify that subset of patients in the denominator who had at least three follow-up visits with a primary care or mental health provider in a twelve-week acute treatment phase after a diagnosis of depression and were prescribed antidepressant medication. Although not shown in the exemplary quality measure screen 400, in some embodiments, quality measure screen 400 may also include one or more templates for specifying numerator information. Furthermore, it should be appreciated that although the use of templates has been described for use with quality measure screen 400, some embodiments may not include templates, but rather may include only fields and/or selectors for entering information. Other embodiments may use a combination of fields, selectors, and templates, as aspects of invention are not limited in this respect.

As described above, some embodiments are directed to matching a provider with one or more performance-based programs that have inclusion criteria specified and stored by a practice management system. The matching process may be facilitated by a plurality of rules that are generated based, at least in part, on the information that is stored for each performance-based program. The plurality of rules may be executed by one or more processors of the practice management system to identify matching quality measures, as described in more detail below.

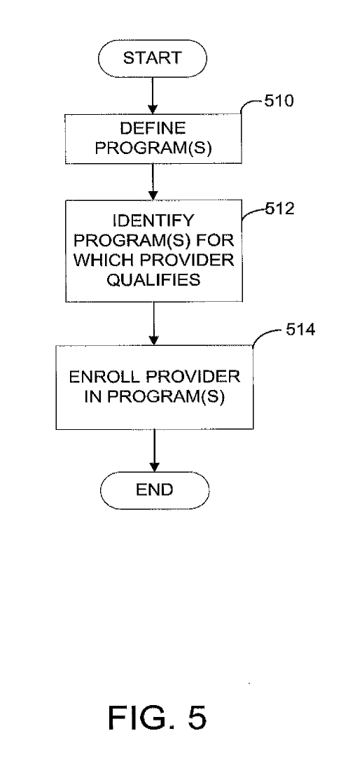

FIG. 5 illustrates such a matching process in accordance with some embodiments of the invention. In act 510, information for one or more performance-based programs may be defined by an administrator using, for example, program administrator screen 300 and/or quality measure screen 400, described above. After at least one performance-based program has been defined, the process proceeds to act 512, where one or more performance-based programs that a provider is qualified for may be identified. Centralization of quality measures related to a plurality of performance-based programs facilitates the program identification process by enabling some embodiments of the invention to match quality measures and other stored information with provider characteristics including, but not limited to, the provider's specialty, the provider's patient mix, practice demographics for the provider, and types of insurance that the provider accepts.

As new performance-based programs are identified and corresponding data is entered into the quality management component of the practice management system, providers that qualify for the newly added performance-based program may be automatically identified and/or enrolled in the program. Additionally, some provider characteristics (e.g., patient mix) and/or program requirements may change periodically. Thus, in some embodiments, a matching process between provider characteristics and performance-based program information managed by the quality management component may be periodically performed to ensure that providers are enrolled in as many performance-based programs for which they qualify.

After qualifying program(s) for a particular provider have been identified, the process proceeds to act 514, where a provider may be enrolled in one or more of the identified programs. The enrollment process may be performed automatically in response to identifying a qualifying program or manually, as embodiments of the invention are not limited in this respect. Enrollment of a provider in one or more identified performance-based programs may be performed in any suitable way. For example, some programs may require that a provider register for the program by providing identifying information to the program sponsor, whereas other programs may not require any particular information to be provided to the program sponsor.

In some embodiments in which providers are automatically enrolled in identified qualifying performance-based programs, providers may be given the option of opting out of one or more of the identified qualifying programs to prevent their automatic enrollment in the program. For example, in one implementation, one or more providers in the practice management system may be associated with an enrollment profile that indicates enrollment preferences for the provider and the enrollment profile for a provider may be consulted prior to enrollment to determine whether to enroll the provider in a particular program.

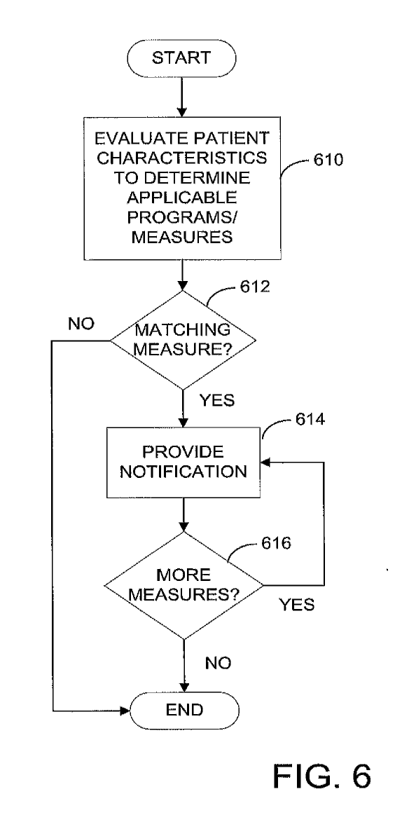

In addition to matching providers with performance-based programs, some embodiments of the invention are directed to matching patient characteristics with quality measures for performance-based programs and providing an indication to providers about patient eligibility during a patient visit at the point of care. FIG. 6 illustrates an exemplary process for providing clinical decision support at the point of care to alert providers when a quality measure applies to a patient during the patient's visit. In act 610, a quality management component of a practice management system may evaluate patient characteristics during a patient visit to determine if one or more quality measures for a performance-based program applies to the patient. For example, in some embodiments, during a patient visit, the quality management component may be configured to access information about a patient's demographics, medical history, insurance information, or any other patient-specific or provider-specific information stored by the practice management system to determine which quality measures (if any) are recommended for the current patient.

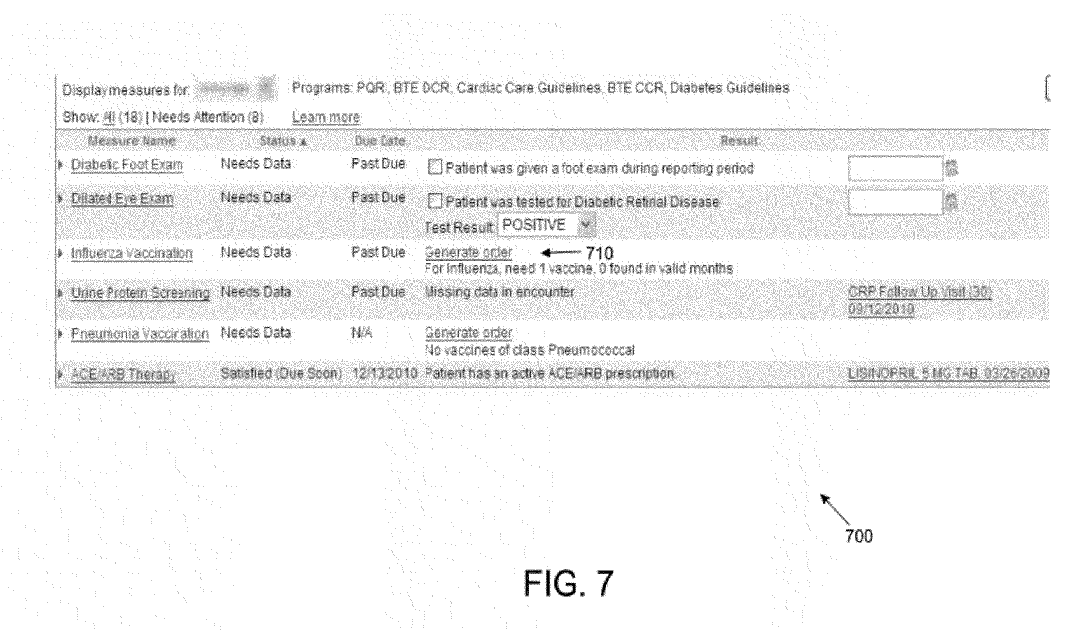

The process then proceeds to act 612, where it is determined if there are any matching quality measures for the current patient. For example, a performance-specific program may include a quality measure that requires all women age fifty years and older to receive yearly mammograms. In this example, when a patient arrives for their patient visit, the patient's demographic information including their age and gender and the patient's medical history may be accessed by the quality management component and it may be determined in act 612 that the current patient is due for an annual mammogram to satisfy the quality measure. If at least one quality measure is identified, the process proceeds to act 614, where a provider may receive a notification at the point of care indicating that an action is recommended (in this case, ordering a mammogram) to satisfy the quality measure. An exemplary notification in accordance with some embodiments of the invention is shown in FIG. 7 and is described in more detail below. By providing notifications to healthcare providers during a patient visit, providers may be in a better position to ensure that all quality measures required to be reported by performance-based programs in which the provider is enrolled are satisfied.

The process proceeds to act 616, where it is determined if there are more matching quality measures for the current patient. If it is determined that there are more matching quality measures, process control returns to act 614 to provide a notification of the quality measure to a provider. However, if it is determined in act 616 that there are no other matching quality measures, the process ends.

In some embodiments, at least some matching quality measures for patients that are scheduled for a patient visit may be determined prior to an actual patient visit. In such embodiments, quality management component may interact with a scheduling component of the practice management system to determine which patients have upcoming patient visits and to determine which quality measures should be recommended at the upcoming patient visits to satisfy the reporting requirements for one or more performance-based programs.

In some embodiments, the quality management component of the practice management system may identify matching quality measures for patients at times other than when the patient is being seen at a medical practice. For example, in some embodiments, the practice management system may keep track of changes to patient information stored by the practice management system since a previous quality management assessment by the quality management component. Changes to patient information include, but are not limited to, changes in patient demographics, insurance coverage, lab result availability, and claims being issued or paid. Changes to patient information may be tracked by the patient management system in any suitable way as aspects of the invention are not limited in this regard. For example, when patient information is added or edited, the patient management system may flag the patient as having a patient information change, such that the patient is included in the next quality management assessment by the quality management engine. In some embodiments, a quality management assessment may occur at predetermined time intervals (e.g., daily), and some or all patients with changed information may be analyzed by the quality management component to determine the extent to which quality measures apply to one or more of the patients with changed patient information. By processing patients with changed data, more potential matching quality measures may be identified between patient visits.

As discussed above, FIG. 7 illustrates an exemplary notification for quality measures that a healthcare provider may receive in accordance with some embodiments of the invention. Notifications may be provided in any suitable format and multiple notification for different quality measures may be provided separately or multiple notifications may be combined into a single group of notifications, as aspects of the invention are not limited in this respect.

FIG. 7 illustrates an exemplary output of a quality measure matching process described above in connection with FIG. 6. In the example of FIG. 7, eighteen quality measures have been identified by the quality management component for the patient, eight of which are recommended as requiring attention during the patient visit. Notifications may include any suitable information that enables a provider to facilitate clinical decisions during the patient visit. For example, a notification may include the name of the quality measure, an indication of whether the measure has been completed or not, a due date for when the measure should be completed by, and a result of the measure that may be used for reporting purpose to satisfy the requirements of one or more performance-based programs that include the quality measure.

In the exemplary notification of FIG. 7, the quality measures are arranged as a quality measure “inbox,” in which a provider may quickly identify which measures are recommended during the visit. However, it should be appreciated that any other suitable type of interface for presenting one or more notifications may also be used and aspects of the invention are not limited in this respect. As shown in FIG. 7, in some embodiments, a notification may include an interactive interface to enable the provider to perform one or more tasks by interacting with the interface to satisfy the quality measure. For example, notification 700 indicates that the patient is due to receive an influenza vaccination. To satisfy this quality measure, a provider may interact with link 710 to generate an order for the influenza vaccination for the patient. Once the order is placed, this information may be transmitted to various healthcare staff at the medical practice, such as pharmacy staff to dispense the influenza vaccine and/or nursing staff to administer the vaccine.

In some embodiments, as quality measures are completed during a patient visit, the status associated with the quality measure may be updated to reflect that the measure has been satisfied. Alternatively, satisfied quality measures may be removed from a list of active quality measures for a particular patient.

In some embodiments, similar or identical quality measures for different performance-based programs may be identified to assure that a provider is notified about the shared quality measure only once during the patient visit. By identifying shared quality measures across multiple programs, the notification process during patient visits becomes more manageable because providers are not prompted multiples times for the same or similar quality measures. Furthermore, data associated with a shared quality measure may be disseminated to all of the programs that recommended the quality measure. Accordingly, the provider is able to participate in multiple programs thereby increasing potential revenue without spending an undue amount of time trying to sort through too many recommended measures during a patient visit.

Another difficulty with conventional systems for participating in performance-based programs is that different programs often require data to be formatted and transmitted to program sponsors in a particular way. Applicants have recognized and appreciated that such systems may be improved by storing information related to the desired format and method of transfer for transmitting data to program sponsors for performance-based programs. Furthermore, in some embodiments, the stored preference information for particular programs may be leveraged to automatically send data and/or reports periodically or on-demand to program sponsors in the format required by the particular sponsor.

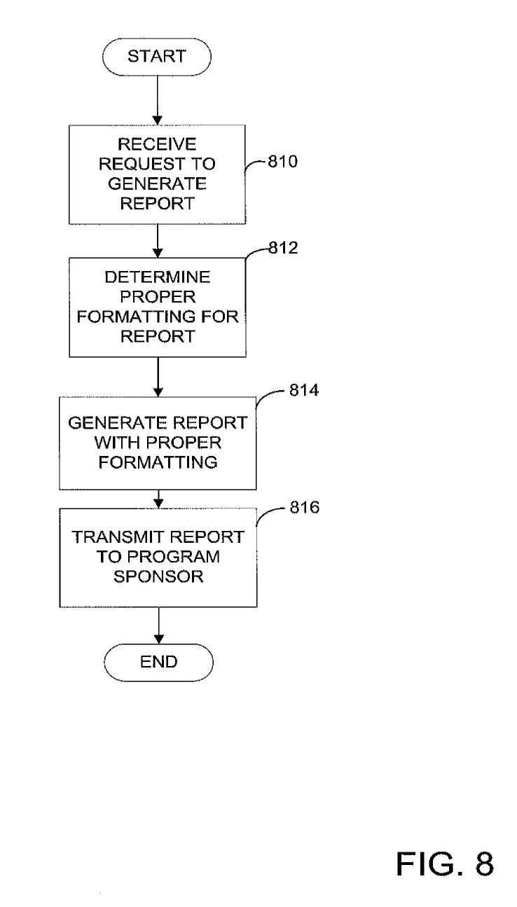

FIG. 8 illustrates a method for reporting quality measure data to one or more performance-based program sponsors in accordance with some embodiments of the invention. In act 810, a request is received to generate a report including data related to at least one quality measure assessment by a provider. In some embodiments, the request may be automatically generated periodically (e.g., every two weeks) in accordance with reporting information associated with a particular program. For example, as described above, when a program is defined using program administrator screen 300, a user may specify reporting information such as a reporting period and a frequency for making submissions to the program sponsor. The request may also be generated manually by, for example, interacting with a portion of a user interface presented to a user by the quality management component.

After a request has been received, the process proceeds to act 812, where the proper formatting of the report is determined. In some embodiments, the proper formatting for a report may be determined based, at least in part, on stored information associated with the performance-based program identified in the request. As discussed above, such information may have been specified by a user when the performance-based program was defined or edited.

After the desired formatting for a report has been determined, the process proceeds to act 814, where the report is generated in accordance with the desired formatting. For example, a performance-based program may require that reports be submitted in Microsoft Excel® format. A reporting component of the practice management system may access the information about this reporting requirement and may generate a report in the appropriate format. After the report is generated, the process proceeds to act 816, where the report is transmitted to the program sponsor. As discussed above, reports may be transmitted automatically at predefined intervals and/or reports may be transmitted to program sponsors manually upon request from a provider or other user.

In some instances, a performance-based program may require that a provider review and approve reports sent to program sponsors before sending the report. In some embodiments, when a report is ready to be reviewed, a provider is sent a notification indicating that the report must be reviewed and approved prior to transmission. Upon receiving the notification, the provider may review and approve the report using a user interface provided by the practice management system or some other user interface and after approval by the provider, the report may be transmitted to the program sponsor.

In some embodiments, information from the quality management component may be integrated with other components of the practice management system to provide additional functionality conventional quality management system(s) do not provide. For example, the quality management component may be integrated with a communication component of the practice management system to determine which patients have quality measures that are out of an acceptable range for one or more performance-based programs and to send an automated communication to the identified group of patients. As an example, patients who have not been administered a flu vaccine for the current year may be determined by the quality management component. The quality management component may then interact with a communication component of the practice management system to provide automated outreach to the patients in the identified group to instruct the patients that an action, such as scheduling an appointment to receive the flu vaccine, should take place. In some embodiments, the communication component may manage automated communications using campaigns, and all patients in a group identified by the quality management component may be included in a campaign to be contacted using a method of automated outreach. Automated outreach may be performed in any suitable way, such as via an automated phone call, text message, page, e-mail, mail, or any other suitable form of communication that the patient has designated. By enabling multiple components of the practice management system to interact in this way, the number of patients satisfying quality measures for a provider may be improved.

Interaction between the quality management component and other components of the practice management component, including a communications component, may also result in a method of providing patients with educational information regarding their health information. For example, in some embodiments, the quality management component may be integrated with a communications component of practice management system to display quality data for a patient as a portion of a web portal that is accessible by the patient. The displayed quality data may, among other things, help patients interpret information such as lab results and other information displayed through the portal. Thus, notifications regarding quality measures and quality data for patients may be provided not only to providers and program sponsors, but such quality data may also be used to inform patients directly about their medical care and how to interpret various types of health information stored by the practice management system.

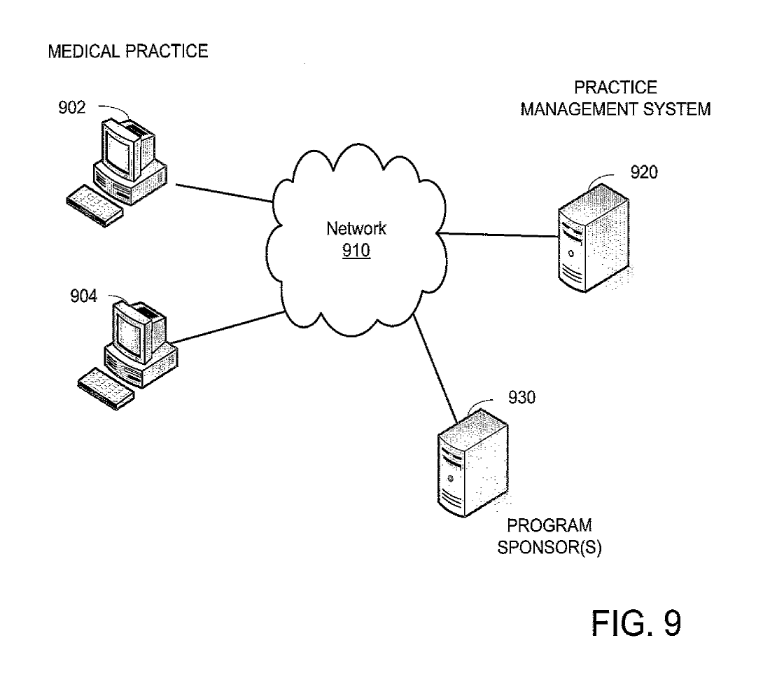

FIG. 9 illustrates an exemplary networked system on which some embodiments of the invention may be employed. Networked computers 902 and 904 located at a medical practice, program sponsor computer 930, and computer 920 located at a location associated with a practice management system are shown connected to a network 910. Network 910 may be any type of local or remote network including, for example, a local area network (LAN) or a wide area network (WAN) such as the Internet. In the example of FIG. 9, four networked computers are shown. However, it should be appreciated that network 910 may interconnect any number of computers of various types and the networked system of FIG. 9 is provided merely for illustrative purposes. For example, computer 920 may be connected via network 910 (or other networks) to a plurality of computers at a plurality of medical practice locations to provide practice management services to each of the connected medical practices. As should be appreciated from the foregoing, embodiments of the invention may be employed in a networked computer system regardless of the type or network size or configuration.

Having thus described several aspects of some embodiments of this invention, it is to be appreciated that various alterations, modifications, and improvements will readily occur to those skilled in the art.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a non-transitory tangible computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The indefinite articles “a” and “an,” as used herein, unless clearly indicated to the contrary, should be understood to mean “at least one.”

The phrase “and/or,” as used herein, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” shall have its ordinary meaning as used in the field of patent law.

As used herein in, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method of providing clinical decision support to a healthcare provider, the method comprising:
determining, with at least one processor, whether at least one quality measure applies to a patient, wherein the at least one quality measure is associated with at least one performance-based program; and
providing, in response to determining that the at least one quality measure applies to the patient, a notification indicating at least one recommended action that, when performed, satisfies the at least one quality measure in compliance with the at least one performance-based program.

2. The method of claim 1, further comprising:
updating a status of the notification in response to determining that the at least one action indicated in the notification is complete.

3. The method of claim 1, further comprising:
storing in at least one datastore, eligibility information for a plurality of performance-based programs;
wherein determining whether the at least one quality measure applies to the patient comprises comparing at least one patient characteristic with the eligibility information for a least one of the plurality of performance-based programs.

4. The method of claim 3, wherein the at least one patient characteristic comprises medical history information.

5. The method of claim 1, further comprising:
generating at least one report for the at least one performance-based program, wherein the report is based, at least in part on a status of the at least one quality measure; and
transmitting over at least one network, the at least one report to at least one program sponsor of the at least one performance-based program.

6. The method of claim 5, further comprising:
retrieving formatting information for the at least one report; and
generating the at least one report in accordance with the retrieved formatting information.

7. The method of claim 1, further comprising:
identifying at least one shared quality measure specified in at least two performance-based programs; and
generating a single notification for the at least one shared quality measure.

8. The method of claim 7, further comprising:
generating at least two reports for the at least two performance-based programs;
wherein each of the at least two reports includes a status of the at least one shared quality measure.

9. The method of claim 1, wherein the notification is provided to the healthcare provider during a patient visit.

10. The method of claim 1, further comprising:
displaying the notification on a portion of a user interface;
wherein the user interface includes at least one link that enables the healthcare provider to perform the at least one action.

11. The method of claim 1, wherein the at least one performance-based program is a pay-for-performance program.

12. The method of claim 1, wherein the notification is provided to the patient via a communication outreach method specified by the patient.

13. At least one computer-readable medium encoded with a plurality of instructions that, when executed by a computer, perform a method, the method comprising:
accessing at least one storage device configured to store eligibility information for a plurality of performance-based programs;
determining based, at least in part, on a matching between the eligibility information and at least one characteristic of a healthcare provider, whether the at least one healthcare provider qualifies for at least one of the plurality of performance-based programs; and
enrolling, when it is determined that the at least one healthcare provider qualifies for the at least one of the plurality of performance-based programs, the at least one healthcare provider in the at least one of the plurality of performance-based programs.

14. The at least one computer-readable medium of claim 13, wherein the matching is performed in response to detecting a change in the eligibility information.

15. The at least one computer-readable medium of claim 14, wherein the change comprises storage of additional eligibility information for a performance-based program on the at least one storage device.

16. A computer system, comprising:
at least one storage device configured to store a plurality of computer-readable instructions; and
at least one processor programmed to execute the plurality of computer-readable instructions to perform a method, comprising:
determining whether at least one quality measure applies to a patient, wherein the at least one quality measure is associated with at least one performance-based program; and
providing, in response to determining that the at least one quality measure applies to the patient, a notification indicating at least one recommended action that, when performed, satisfies the at least one quality measure in compliance with the at least one performance-based program.

17. The computer system of claim 16, wherein the method further comprises:
storing on the at least one storage device, eligibility information for a plurality of performance-based programs;
wherein determining whether the at least one quality measure applies to the patient comprises comparing at least one patient characteristic with the eligibility information for at least one of the plurality of performance-based programs.

18. The computer system of claim 16, further comprising:
generating at least one report for the at least one performance-based program, wherein the report is based, at least in part on a status of the at least one quality measure; and
transmitting over at least one network, the at least one report to at least one program sponsor of the at least one performance-based program.

19. The computer system of claim 18, wherein the method further comprises:
retrieving formatting information for the at least one report from the at least one storage device; and
generating the at least one report in accordance with the retrieved formatting information.

20. The computer system of claim 16, wherein the method further comprises:
identifying at least one shared quality measure specified in at least two performance-based programs; and
generating a single notification for the at least one shared quality measure.

21. The computer system of claim 16, wherein the at least one performance-based program is a pay-for-performance program.

22. The computer system of claim 16, wherein the method further comprises:
displaying the notification on a web portal accessible by the patient.

23. The computer system of claim 16, wherein the method further comprises:
interacting with a communication component of the computer system to transmit at least one automated message to the patient, wherein the at least one automated message includes the notification.

24. The computer system of claim 16, wherein the method further comprises:
tracking changes to patient health information stored by the at least one storage device for a plurality of patients;
identifying patients with changes to patient health information since a predetermined time; and
performing the method for the identified patients.

25. The method of claim 24, wherein the predetermined time is a last time that the method was performed.
